(19) United States
(12) Patent Application Publication
(10) Pub. No.: US 2021/0174330 A1
(43) Pub. Date: Jun. 10, 2021

(54) Apparatus for Supporting In-Vehicle Payment System, System Having the Same and Method Thereof

(71) Applicants: Hyundai Motor Company, Seoul (KR); Kia Motors Corporation, Seoul (KR)

(72) Inventors: Se Hee Kim, Seoul (KR); Tae Hyun Sung, Seoul (KR)

(21) Appl. No.: 16/837,587

(22) Filed: Apr. 1, 2020

(30) Foreign Application Priority Data
Dec. 5, 2019 (KR) 10-2019-0160948

(51) Int. Cl. G06Q 20/30; G06Q 20/22

(52) U.S. Cl. CPC G06Q 20/308; G06Q 20/29

(57) ABSTRACT

An in-vehicle payment service apparatus an input device configured to receive information selected from a user in a vehicle and a processor configured to identify the information selected through the input device and to control the selected information to be displayed on a display in the vehicle. The processor is also configured to manage a payment state for the selected information, transfer information for the payment state to a specific vehicle in a group driving mode, and allow the specific vehicle to perform a payment approval.

### CROSS-REFERENCE TO RELATED APPLICATIONS

This application claims priority to Korean Patent Application No. 10-2019-0160948, filed in the Korean Intellectual Property Office on Dec. 5, 2019, which application is hereby incorporated herein by reference.

### TECHNICAL FIELD

The present disclosure relates to an apparatus for supporting an in-vehicle payment system, a system including the same, and a method thereof.

### BACKGROUND

Recently, a concept of a vehicle evolves from a concept of transportation means or vehicles to a space for culture and/or life. Furthermore, development of communication technology according to increasing convergence of technology in electronic communication devices in vehicles and user service needs has expanded the concept of the vehicle, such as extending the vehicle to a kind of communication device.

As the emergence of more convenient and human-friendly advanced features, an infotainment system in the vehicle is developing into an integrated service system of information that means necessary information such as a driving and route guide, and entertainment that provides a variety of entertainment, culture, and community. Beyond combining vehicle navigation, audio and video, and the internet, recently, due to popularization of smartphones and tablet PCs, and development of information technology (IT), a technology level and a market are growing year after year. In other words, the vehicle is changing from hardware vehicle devices to the base of a service platform functioning as software as well as content devices.

As an example, a tablet PC installed in the vehicle and a user's smartphone are developing in a manner in which they are automatically associated with each other. As part of the function to transfer not only basic information such as traffic or weather, but also a text message of the smartphone into voice, a rescue signal is automatically sent when a big accident occurs while driving. As part of the function of remotely starting an engine of the vehicle or diagnosing a fault condition, a service of controlling temperature after starting the engine of the vehicle parked outside during the cold winter is introduced.

Moreover, recently, various services for in-vehicle financial transactions are required, and in this regard, specific payment methods for electronic commerce and financial transactions are required.

### SUMMARY

Embodiments of the present disclosure can solve the above-mentioned problems occurring in the prior art while advantages achieved by the prior art are maintained intact.

The present disclosure relates to an apparatus for supporting an in-vehicle payment system, a system including the same, and a method thereof. Particular embodiments relate to a technique that performs a menu selection and payment authority in a vehicle during group driving.

An embodiment of the present disclosure provides an apparatus for supporting an in-vehicle payment system, a system including the same, and a method thereof.

Another embodiment of the present disclosure provides an apparatus for collectively making a payment for other vehicles in a vehicle that performs a group driving, a system including the same, and a method thereof.

Another embodiment of the present disclosure provides an apparatus for identifying an information selection and for making a payment for other vehicles in a vehicle that performs a group driving, a system including the same, and a method thereof.

Another embodiment of the present disclosure provides an apparatus for performing an information selection and for transferring a payment for other vehicles in a vehicle that performs a group driving, a system including the same, and a method thereof.

Another embodiment of the present disclosure provides an apparatus for performing a group driving between vehicles, which controls an information selection and a transfer of payment authority, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, an in-vehicle payment service apparatus includes an input device that receives information selected from a user in a vehicle, and a processor that identifies the information selected through the input device, and controls the selected information to be displayed on a display in the vehicle, wherein the processor controls to manage a payment state for the selected information, transfer information for the payment state to a specific vehicle in a group driving mode, and allow the specific vehicle to perform a payment approval.

In an embodiment, the processor allows at least two or more vehicles to be set as vehicles in the group driving mode by identifying the information input through the input device, and allows a first vehicle in the group driving mode to be set as the specific vehicle.

In an embodiment, the processor allows a corresponding vehicle to be set as a group driving mode vehicle for the group driving mode by identifying whether the corresponding vehicle selects the group driving mode, whether the corresponding vehicle selects the same destination, whether the corresponding vehicle shares the same destination, or whether the corresponding vehicle sets the same point of interest (POI), based on information for the vehicles input through the input device.

In an embodiment, the processor allows the first vehicle in the group driving mode to perform a menu selection for vehicles other than the first vehicle.

In an embodiment, the processor allows the first vehicle in the group driving mode to perform a payment for the menu selected by the vehicles other than the first vehicle.

In an embodiment, the processor identifies whether the specific vehicle in the group driving mode selects a group payment mode, selects a vehicle for a group payment based on the group payment mode, and controls the selected vehicle to perform the payment.

In an embodiment, the processor identifies whether a payment request occurs from remaining vehicles in the group driving mode to the specific vehicle, wherein the remaining vehicles select a license plate number or a vehicle information list for the specific vehicle for the payment request.

In an embodiment, the processor identifies whether each vehicle in the group driving mode is subscribed to an in-vehicle payment service, and allows the display in the vehicle to display a guide pop-up screen, a login screen, or a card registration screen for performing the in-vehicle payment service.

In an embodiment, the processor allows each vehicle in the group driving mode to identify the guide pop-up screen, the login screen, or the card registration screen, which are displayed through the display in the vehicle and to register the in-vehicle payment service through the input device.

In an embodiment, the processor allows the display to display a selected menu and payment information for all vehicles in the group driving mode, wherein the display includes an audio video navigation screen (AVNT).

According to an embodiment of the present disclosure, an in-vehicle payment service method includes receiving information through an input device in a vehicle from a user, identifying the information selected through the input device, and controlling the selected information to be displayed on a display in the vehicle, wherein the controlling of the selected information includes managing a payment state for the selected information, transferring information for the payment state to a specific vehicle in a group driving mode, and allowing the specific vehicle to perform a payment approval.

In an embodiment, the controlling of the selected information includes allowing at least two or more vehicles to be set as vehicles in the group driving mode by identifying the information input through the input device, and allowing a first vehicle in the group driving mode to be set as the specific vehicle.

In an embodiment, the controlling of the selected information includes identifying whether a corresponding vehicle selects the group driving mode, whether the corresponding vehicle selects the same destination, whether the corresponding vehicle shares the same destination, or whether the corresponding vehicle sets the same point of interest (POI), based on information for the vehicles input through the input device, and allowing the corresponding vehicle to be set as a group driving mode vehicle for the group driving mode.

In an embodiment, the controlling of the selected information includes allowing the first vehicle in the group driving mode to perform a menu selection for vehicles other than the first vehicle.

In an embodiment, the controlling of the selected information includes allowing the first vehicle in the group driving mode to perform a payment for the menu selected by the vehicles other than the first vehicle.

In an embodiment, the controlling of the selected information includes identifying whether the specific vehicle in the group driving mode selects a group payment mode, selecting a vehicle for a group payment based on the group payment mode, and controlling the selected vehicle to perform the payment.

In an embodiment, the controlling of the selected information includes identifying whether a payment request occurs from remaining vehicles in the group driving mode to the specific vehicle, and allowing the remaining vehicles to select a license plate number or a vehicle information list for the specific vehicle for the payment request.

In an embodiment, the controlling of the selected information includes identifying whether each vehicle in the group driving mode is subscribed to an in-vehicle payment service, and allowing the display in the vehicle to display a guide pop-up screen, a login screen, or a card registration screen for performing the in-vehicle payment service.

In an embodiment, the controlling of the selected information includes allowing each vehicle in the group driving mode to identify the guide pop-up screen, the login screen, or the card registration screen, which is displayed through the display in the vehicle, and allowing each vehicle in the group driving mode to register the in-vehicle payment service through the input device.

In an embodiment, the controlling of the selected information includes allowing the display to display a selected menu and payment information for all vehicles in the group driving mode, wherein the display includes an audio video navigation screen (AVNT).

### BRIEF DESCRIPTION OF THE DRAWINGS

The above and other objects, features and advantages of the present disclosure will be more apparent from the following detailed description taken in conjunction with the accompanying drawings, in which:

FIG. 1 is a block diagram illustrating an in-vehicle payment system according to an embodiment of the present disclosure;

FIG. 2 is a diagram illustrating an in-vehicle payment platform according to an embodiment of the present disclosure;

FIG. 3 is a flowchart describing an in-vehicle payment procedure during a group driving according to an embodiment of the present disclosure;

FIG. 4 is a diagram illustrating a structure of an input/output device for a user selection in a vehicle according to an embodiment of the present disclosure; and

FIG. 5 is a block diagram illustrating a computing system for executing an in-vehicle payment procedure according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

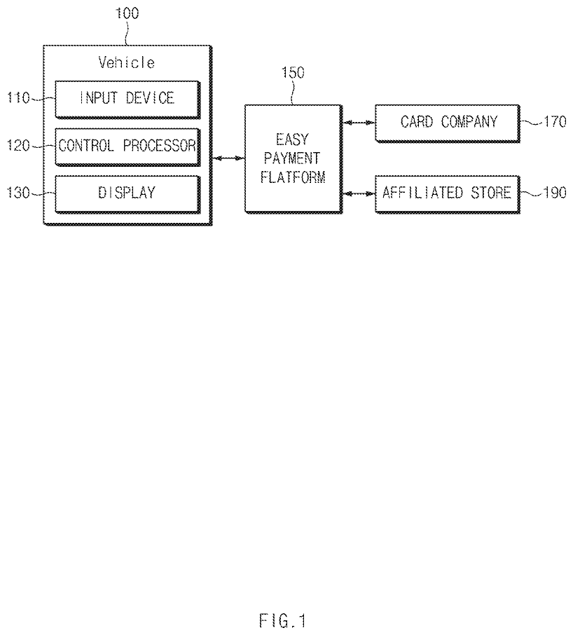

Hereinafter, embodiments of the present disclosure will be described in detail with reference to FIGS. 1 to 5.

FIG. 1 is a block diagram illustrating an in-vehicle payment system according to an embodiment of the present disclosure.

Referring to FIG. 1, a vehicle loo according to an embodiment of the present disclosure may include an input device no, a control processor 120, and a display 130.

The input device no is a hardware device that is implemented in various electronic circuits for transmitting and receiving signals over a wireless or wired connection. In the present disclosure, the input device no may perform in-vehicle communication through a Controller Area Network (CAN) communication, a Controller Area Network with Flexible Data-Rate (CAN-FD) communication, a Local Interconnect Network (LIN) communication, an Ethernet communication, or the like. The input device no may include various communication units such as a mobile communication unit for communication with a server outside a vehicle and an external diagnostic apparatus, a broadcast receiving unit such as a Digital Multimedia Broadcasting (DMB) module or a Digital Video Broadcasting-Handheld (DVB-H) module, a short range communication unit such as a Zigbee module, a Bluetooth module, or a National Electric Code (NEC) module, a Wi-Fi communication unit, or the like. In particular, the input device no according to the present disclosure is a device capable of inputting a user's payment to proceed, and may include an Audio Video Navigation (AVN) screen touch.

The control processor 120 may be electrically connected to the input device no, the display 130, and the like, and may electrically control each of components. The control processor 120 may be an electrical circuit that executes a command of software, and thus may include a processor that performs various data processing and calculations, which will be described later.

In particular, according to an embodiment of the present disclosure, the control processor 120 may direct a menu selection or collective payment in a specific vehicle that transfers the menu selection or payment authority during a group driving. Accordingly, the control processor 120 may identify/determine elements (the group driving, a vehicle selected for the same destination, a destination sharing) for determining whether a group is the same group. The control processor 120 may provide the same payment or approval procedure for vehicles grouped in the same group.

For example, when vehicles A, B, and C that move as the same group arrive at a drive through McDonald's store, the control processor 120 may receive menu data provided by a corresponding affiliated store through the server. The control processor 120 may identify the menu selected by each passenger of the vehicles through a terminal of each vehicle. When a passenger of the vehicle A who wants to pay in bulk selects a ‘group payment mode’ and then selects the vehicles B and C from a list of vehicles driving in the group through the terminal of the vehicle A, the control processor 120 may allow the terminal of vehicle A to receive and display menus and price information selected by the vehicles B and C. Accordingly, the control processor 120 may allow the vehicle A to pay for the menus selected by the vehicles B and C as well.

As another example, when vehicles A, B, and C that move as the same group arrive at a gas station, the control processor 120 may receive refuelable data provided by a corresponding affiliated store of the vehicle through a server, and may identify that passengers select a fueling amount or a fueling volume through the terminal of each vehicle. That is, the control processor 120 may identify that the fueling amount is selected in each of vehicles A and B, and may identify that a ‘request payment to another vehicle’ is selected in the vehicles A and B. When the passengers of vehicles A and B select the vehicle C in the vehicle list and select ‘Request payment’, the terminal of vehicle C may receive information on the fueling amount required for payment of the vehicles A and B. The control processor 120 may allow the vehicle C to pay the fueling amount selected by the vehicles A and B as well.

As another example, when a vehicle A arrives at a drive through store first among vehicles A, B, and C that move as the same group, the control processor 120 may allow the vehicle A to collectively select menus of the vehicles A, B, and C grouped together, and may allow the vehicle A to select ‘proceed payment on the last arrival vehicle’ among payment options. Accordingly, when the vehicle C last arrives at the drive through store, the control processor 120 may allow the vehicle C to make payments automatically and may allow an order to be entered at that time.

As described, the control processor 120 receives and identifies data selected by the user through the input device no of each vehicle in the same group with each other, and then may identify a selection and a payment transfer for a corresponding service. The control processor 120 may control a final payment through an identification with the server and a payment system. That is, the control processor 120 may perform checks of whether the in-vehicle payment service is subscribed and available, a CP connection and affiliated store DB management, a vehicle transfer data management for payment by an ICPS connection, a payment progress state management, a data management for vehicle information transmission and reception, and the like.

In addition, the control processor 120 may allow a screen for receiving an approval from the user to be displayed, or may allow a notification for the approval to the user to be output by controlling the input device 110 and the display 130. In this case the control processor 120 may be configured to include storage therein. Alternatively, the control processor 120 may be electrically connected to storage configured separately from the control processor 120 in the vehicle. The control processor 120 may control the separately configured storage and may identify data of the storage.

The storage according to embodiments of the present disclosure may download and store data for a payment service through the input device 110. The data may be vehicle payment data that are received from a card company 170 or an affiliated store 190 and an easy payment platform 150 server, and may be data selected through each vehicle. In this case, the storage may store data in a form of adding/deleting/maintaining data that are received or updated through a corresponding server as necessary. In addition, the storage may store at least one or more of the network load, a power state of a vehicle, a battery state, and an estimated transmission time of a remaining ROM data, which are determined by the control processor 120. In addition, to support payment and autonomous driving services according to embodiments of the present disclosure, the storage may store location information between vehicles driving in a group, intervals between vehicles, moving distances, time information according to each location, and road information. The storage may store identification information for identifying a user who performs the group driving.

The storage may include at least one type of storage medium of a memory that has memory types such as a flash memory type, a hard disk type, a micro type, and a card type (e.g., an SD card or an XD card), or the like and a memory that has memory types such as a random access memory (RAM), a static RAM (SRAM), a read-only Memory (ROM), a programmable ROM (PROM), an electrically erasable PROM (EEPROM), a magnetic random access memory (MRAM), a magnetic disk, and optical disk.

The display 130 may display data selected by the user of the vehicle and data depending on an input, and may display a screen for receiving user authentication, and the like, under control of the control processor 120. The display 130 may be implemented as a head-up display (HUD), a cluster, an AVNT (audio video navigation telematics), or the like. That is, the display 130 may display the menu selection, the transfer of payment authority, a payment progress state, and the like, and may be implemented as an AVN display, the cluster, or the like. In addition, the display 130 may include at least one of a liquid crystal display (LCD), a thin film transistor liquid crystal display (TFT LCD), a light emitting diode (LED) display, and an organic light emitting diode (OLED) display, an active OLED (AMOLED, Active Matrix OLED) display, a flexible display (flexible display), a bended display, and a three-dimensional display (3D display). Some of the displays described above may be implemented as a transparent display configured to be transparent or translucent such that the user may see an outside. In addition, the display 130 may be provided as a touch screen including a touch panel and may be used as the input device in addition to an output device.

The easy payment platform 150 (e.g., in-vehicle payment system) according to embodiments of the present disclosure may include a platform for an overall payment service interworking, such as a payment services, a payment card management, an affiliated store management, a payment service management, or the like, which are included in the connected vehicle service (CCS). The easy payment platform 150 may include a telematics center or an external server for performing an easy payment service for the vehicle 100. The server for the easy payment platform 150 may include a server for selectively providing and supporting data for various vehicle sensors, road information, and communication information for supporting the autonomous driving to which embodiments of the present disclosure are applied, and data provided by the card company 170 and the affiliated store 190. Here, the card company 170 and the affiliated store 190 may provide lists of payable cards in the vehicle 100 and lists of the affiliated stores and related contents.

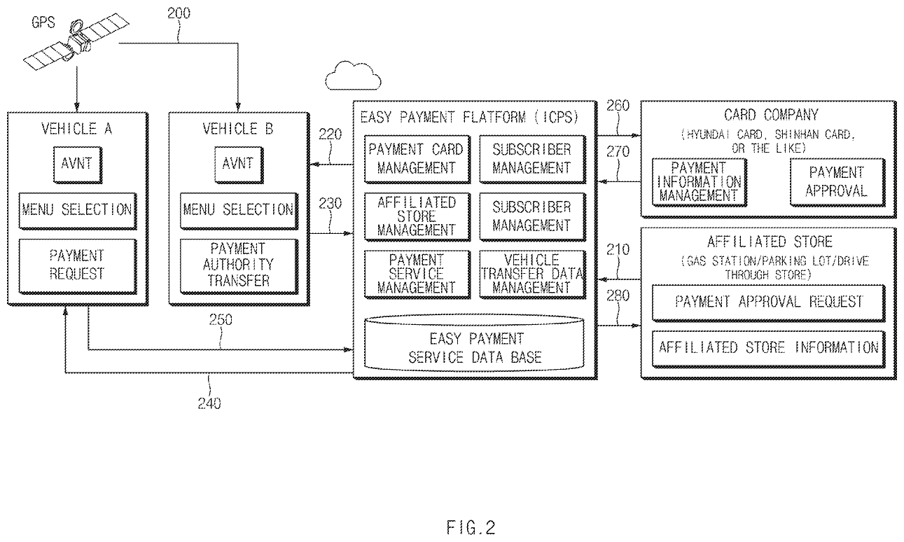

FIG. 2 is a diagram illustrating an in-vehicle payment platform according to an embodiment of the present disclosure.

Referring to FIG. 2, an easy payment platform system may manage/store data for the easy payment service from the affiliated store and the card company in the form of a database. For example, the easy payment platform system may manage/store the data to be displayed in an adaptive form, based on a user setting and a user request of an application using the easy payment service. The easy payment platform system may manage/store the data as for each data about the affiliated store, in the form of each list, and for each item. The data for the affiliated store may be changed to update/delete as needed. For example, the easy payment platform may include affiliated store information for gas station/parking lot/drive through store, and menu information and status information of each affiliated store (210).

When the vehicles enter within an effective area of the affiliated store (200), a vehicle B may receive affiliated store data from the easy payment platform server (220). The vehicle B may identify the affiliated store data such as menu information, parking fee, or fueling information, which are provided through the display (e.g., AVNT), may select a corresponding menu, and then may request the transfer of payment authority to a vehicle A. In this case, the vehicle B transmits the selected menu selection information and data about the vehicle A to the easy payment platform system (230).

The vehicle A receives data for vehicle B and menu information for vehicle B from the easy payment platform server (240). The vehicle A identifies the affiliated store data, for example, menu information, parking fee, fueling information, which are provided through the display (e.g., the AVNT), selects a menu of the corresponding affiliated store, and then transmits data including data (vehicle information and menu data) of the provided vehicle B to the easy payment platform system (250). That is, the vehicle A transmits the A/B menu selection information and the A/B vehicle data information to the easy payment platform to perform the payment request for the A/B vehicle. The easy payment platform receives the information from the vehicle A and requests the payment of the sum of the A/B vehicles to the selected card company (260). The card company may include a payment company that manages and approves payment information, such as Hyundai Card, Shinhan Card, Lotte Card, Kakao Pay, MasterCard, Visa, Venmo and the like. In addition, the card company may include a telecommunication company that manages and approves payment information. The card company performs the payment approval based on the data transmitted from the vehicle A, and then transmits the approval data to the easy payment platform (270). After confirming this, the easy payment platform transmits the menu information selected by each of the A/B vehicles and data on the A/B vehicles to the corresponding affiliated store to complete the service payment (280).

According to one embodiment of the present disclosure, since a service platform and communication technology for paying in the vehicle are provided, a user may more conveniently enjoy an infotainment system of the vehicle. Due to the service platform that may be paid within the vehicle, the fueling amount and parking fees according to the user's needs are easier to pay in the vehicle. In addition, in consideration of changes in the service market and user services due to the recent increase in service stores having a form of ordering in a vehicle, such as a drive through, when the vehicle stays at a gas station or a drive through store while driving in a group, the payment authority is transferred through a specific vehicle, and a convenience such as the collective payment is provided.

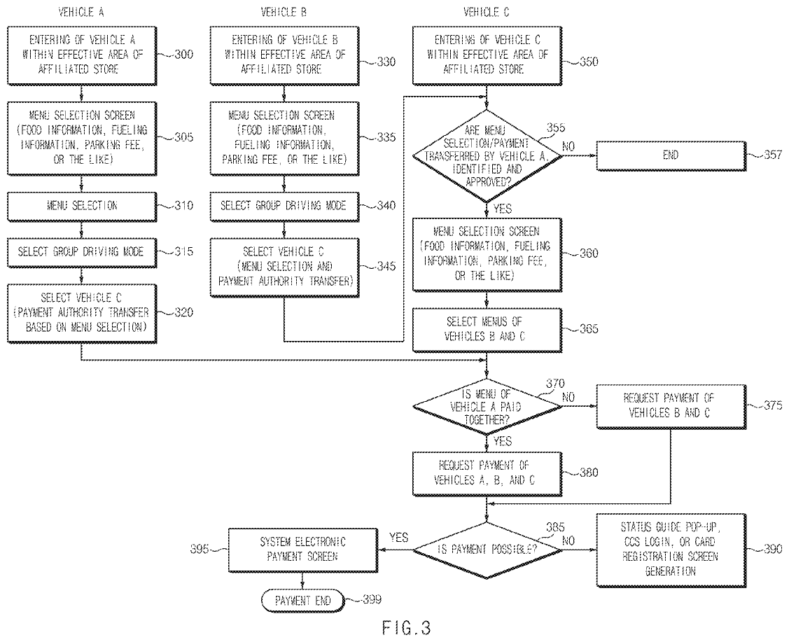

FIG. 3 is a flowchart describing an in-vehicle payment procedure during a group driving according to an embodiment of the present disclosure.

Referring to FIG. 3, the vehicle A may enter within an effective area of a specific affiliated store during driving (300). The specific affiliated store may be a service company using the easy payment service platform. The user of the vehicle A may identify the affiliated store information and data of the affiliated store that are displayed through the AVNT screen in the vehicle A (305). For example, as affiliated store information, data on restaurant information, food information, fueling information, fueling price, parking fee, or the like may be displayed on a menu selection screen. The user may select a specific menu from the displayed information according to an example (310), may select the group driving mode (315), and may select the vehicle C in the group driving mode as the payment vehicle by transferring the payment authority for the selected menu (320). That is, the payment authority may be transferred to any vehicle that is driving in the group, based on the selected menu.

On the other hand, when the vehicle B enters within the effective area of the specific affiliated store during driving (330), the user of vehicle B may also identify the affiliated store information and data of the affiliated store displayed on the AVNT screen in the vehicle (335). The user of vehicle B may identify the data on the restaurant information, the food information, the fueling information, the fueling price, the parking fee, or the like through the menu selection screen. The user of vehicle B may also select a group driving mode (340). In this case, the user of the vehicle B may transfer the selected menu and payment authority to the vehicle C in the group driving mode (345).

Accordingly, when the vehicle C enters within the effective area of the specific affiliated store during driving (350), the user of vehicle C may identify the selected menu and payment authority transfer data of any vehicle in the group driving mode (355). For example, a form of message “vehicle A has asked you for a menu selection and payment. Do you want to approve?” may be displayed on the AVNT screen in the C vehicle. The user of vehicle C may select No. in which case the process ends (357). The user of vehicle C may also select Yes in which case the user of the vehicle C may identify the information of the specific affiliated store, and the data of the specific affiliated store, that is, the restaurant information, the food information, the fueling information, the fueling price, the parking fee, or the like through the menu selection screen, which are displayed on the AVNT screen of the vehicle C (360). Thereafter, the user of the vehicle C may select the menu for the vehicles B and C transferred to the menu selection (365). Thereafter, the user of the vehicle C may identify the payment request information “Do you want to pay the menu selected by the vehicle A together?” displayed on the screen (370). The user of vehicle C may request payment for vehicles A, B, and C (Yes) (380). However, the user of vehicle C may refuse the payment request for vehicle A (No). That is, the user of the vehicle C may perform only payment for the vehicles B and C (375).

The vehicle C may determine whether the payment is possible by referring to a communication possible state, whether a service is opened, a CCS login state, and whether a card is registered (385). When it is determined that the vehicle C is capable of paying (Yes), the system electronic payment screen is displayed (395) and the payment is completed (399). On the other hand, when the payment is impossible in the vehicle C (No), a guide pop-up, CCS login, or card registration screen that is appropriately guided to each state is generated according to the absence of the corresponding information (390).

As described above, according to embodiments of the present disclosure, since the menu selection or payment authority is transferred to the specific vehicle during the group driving, the specific vehicle may select the menu or make the payment collectively. The menu selection or payment authority transfer are equally applicable to vehicles grouped by group driving, vehicles selecting the same destination, destination sharing, and the like.

In other words, the specific vehicle among vehicles grouped in a group may proceed to collective payment by acquiring the payment authority of other vehicles. In this case, the user of the vehicle that wants to make the collective payment selects the ‘group payment mode’ and performs the collective payment by selecting vehicles that are driving in a group and obtaining the payment authority from the selected vehicles.

In addition, a specific vehicle among the vehicles grouped in a group may transfer the payment authority to the terminal of the other vehicle, and the vehicle that receives the payment authority transfer may proceed with the collective payment. In this case, the user of the terminal of the specific vehicle may select ‘Request payment to another vehicle’, and then the user may enter the license number of the vehicle to be transferred payment authority, or the user may select a vehicle that receives payment authority transfer with reference to the nearby vehicle information list. Therefore, the transfer of payment authority may be performed to the vehicle that the user wants to pay. In this case, the terminal of the vehicle that receives the payment authority transfer may collectively perform payment for the menus ordered by the vehicles requesting the payment transfer.

Finally, a specific vehicle among the grouped vehicles may select all menus, and the payment authority may be transferred from the specific vehicle to another vehicle. That is, a terminal of the vehicle that receives the payment authority transfer may collectively pay for orders of the vehicles that request the payment.

In this case, the group between the vehicles for the menu selection sharing and the payment authority transfer (for example, the vehicle target for the transfer of menu selection authority or the transfer of the payment authority) may be defined through various methods as follows. The first is a case where the menu ‘group driving mode’ is provided to perform group driving in the navigation, and the license plate number of another vehicle or a telephone number of the terminal driving in the group is input. The second is a case of a vehicle sharing a destination with the terminal of another vehicle. The third is a case where the vehicle is selected when the same destination is selected or a vehicle driving with the same POI, that is, when the vehicle list which sets the same destination among a host vehicle reference vehicle or the surrounding vehicle is displayed, the corresponding vehicle is selected. Here, the point of interest (POI) is location information of a building around a road that provides a vehicle driver to easily find a target point, and may mean a driver interest point.

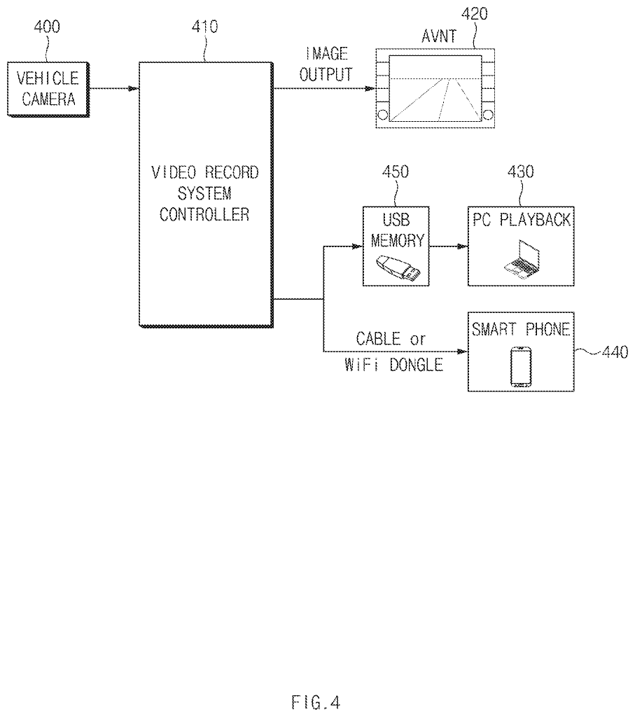

FIG. 4 is a diagram illustrating a structure of an input/output device for a user selection in a vehicle according to an embodiment of the present disclosure.

Referring to FIG. 4, a structure capable of identifying information and surrounding information about a vehicle that performs the group driving, using a drive video record system (DVRS) provided in a vehicle, is illustrated.

The DVRS may interwork with an in-vehicle Audio Video Navigation (AVN) screen 420 and a smartphone 440. Accordingly, the DVRS may include advanced features such as a front and rear high-definition recording, a parking recording, a shock detection mode, an AVN interworking, a smart phone interlocking, an advanced memory management, an embedded memory (eMMC) application, and this may further include functions added for convenience and security of the user. In addition, the stored video may be treated as a target of functions such as playing, editing, deleting, and sharing the video through an AVN screen or a mobile phone application. Functions for small number/object recognition may be expanded by allowing the touch screen to be enlarged. By sharing the recorded video or snapshot through a smart phone-only application and compressing it in a short time, it may be provided to be used adaptively according to the user's lifestyle.

A video record system controller 410 according to embodiments of the present disclosure may compare the surrounding image information input through the camera 400 with the position information provided through the GPS system. This may be provided by adaptively applying. An output of an input image is also available for user confirmation through AVNT 420. According to embodiments of the present disclosure, the image information on the road/periphery input through the camera 400 may be affiliated store information, affiliated store location and road, and location information of the vehicle. In addition, information about the vehicle driving in the group in the location may also be included. In this case, the image information makes it possible to recognize vehicle information, vehicle identification number, license plate, or the like for the vehicle. Through this, as a check of information on various vehicles driving between groups and recognition of information on driving roads, when the surrounding image is recorded by identifying the information of the affiliated stores and the usage information of the affiliated stores received through the GPS system, recorded images may be used to identify the current status of the site and evidence. Recorded images may be stored on USB memory 450 which can be played on PC playback 430. The video record system controller 410 may also communicate with smartphone 440 using a cable or WiFi dongle.

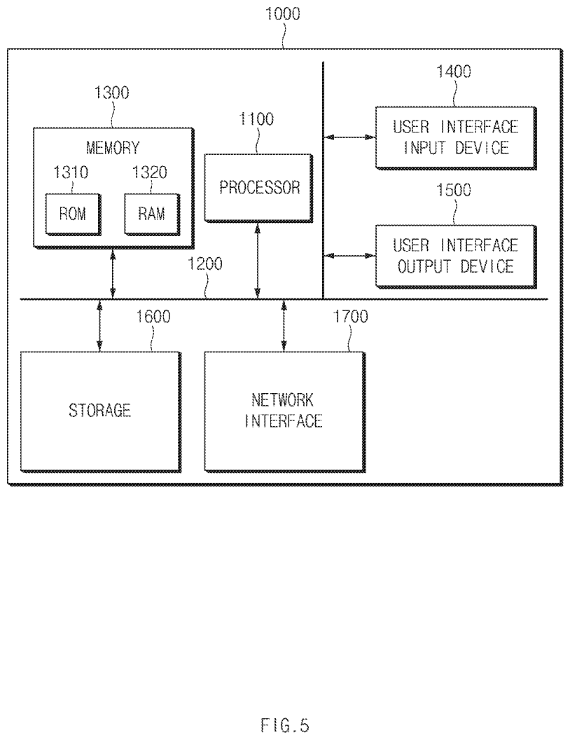

FIG. 5 is a block diagram illustrating a computing system for executing an in-vehicle payment procedure according to an embodiment of the present disclosure.

Referring to FIG. 5, as described above, the in-vehicle payment procedure according to an embodiment of the present disclosure may be implemented through a computing system. The computing system woo may include at least one processor 1100, a memory 1300, a user interface input device 1400, a user interface output device 1500, storage 1600, and a network interface 1700 connected through a system bus 1200.

The processor 1100 may be a central processing unit (CPU), or a semiconductor device that processes instructions stored in the memory 1300 and/or the storage 1600. The memory 1300 and the storage 1600 may include various types of volatile or non-volatile storage media. For example, the memory 1300 may include a read only memory (ROM) and a random access memory (RAM).

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

As set forth above, embodiments of the present disclosure have an advantage of completing a payment service with one payment more conveniently from the user's point of view as a specific vehicle performs a payment for a plurality of vehicles of a group when a group driving is performed. In particular, when vehicles pass through an affiliated store that may accept vehicle payments, such as a drive through, during group driving, as a specific vehicle completes a menu selection or a payment of a selected order for group vehicles at once, a service usage time and a procedure according to the service usage are efficiently utilized.

Therefore, according to embodiments of the present disclosure there is an advantage that the various forms of financial services may be used more easily during a group driving. Thus, an effect of presenting differentiated marketability and direction of payment service is provided. In addition, there is an effect of supporting a better payment service in a more convenient way for service users.

In addition, various effects may be provided that are directly or indirectly understood through embodiments of the present disclosure.

The above description is merely illustrative of the spirit of the present disclosure, and those skilled in the art to which the present disclosure pertains may make various modifications and variations without departing from the spirit and scope of the present disclosure.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An in-vehicle payment service apparatus comprising:
an input device configured to receive information selected from a user in a vehicle; and
a processor configured to identify the information selected through the input device and to control the selected information to be displayed on a display in the vehicle, wherein the processor is further configured to manage a payment state for the selected information, transfer information for the payment state to a specific vehicle in a group driving mode, and allow the specific vehicle to perform a payment approval.

2. The in-vehicle payment service apparatus of claim 1, wherein the processor is configured to allow at least two or more vehicles to be set as vehicles in the group driving mode by identifying the selected information and to allow a first vehicle in the group driving mode to be set as the specific vehicle.

3. The in-vehicle payment service apparatus of claim 2, wherein the processor is configured to allow a corresponding vehicle to be set as a group driving mode vehicle for the group driving mode by identifying whether the corresponding vehicle selects the group driving mode, whether the corresponding vehicle selects a same destination as the specific vehicle, whether the corresponding vehicle shares the same destination as the specific vehicle, or whether the corresponding vehicle sets a same point of interest (POI) as the specific vehicle, based on information for the corresponding vehicle input through an input device of the corresponding vehicle.

4. The in-vehicle payment service apparatus of claim 2, wherein the processor is configured to allow the first vehicle in the group driving mode to perform a menu selection for vehicles other than the first vehicle.

5. The in-vehicle payment service apparatus of claim 4, wherein the processor is configured to allow the first vehicle in the group driving mode to perform a payment for a menu selected by the vehicles other than the first vehicle.

6. The in-vehicle payment service apparatus of claim 1, wherein the processor is configured to identify whether the specific vehicle in the group driving mode selects a group payment mode, to select a vehicle for a group payment based on the group payment mode, and to control the selected vehicle to perform the payment.

7. The in-vehicle payment service apparatus of claim 1, wherein the processor is configured to identify whether a payment request occurs from remaining vehicles in the group driving mode to the specific vehicle, wherein the remaining vehicles are configured to select a license plate number or a vehicle information list for the specific vehicle for the payment request.

8. The in-vehicle payment service apparatus of claim 1, wherein the processor is configured to identify whether each vehicle in the group driving mode is subscribed to an in-vehicle payment service and to allow the display in the vehicle to display a guide pop-up screen, a login screen, or a card registration screen for performing the in-vehicle payment service.

9. The in-vehicle payment service apparatus of claim 8, wherein the processor is configured to allow each vehicle in the group driving mode to identify the guide pop-up screen, the login screen, or the card registration screen, which is displayed through the display in the vehicle and to register the in-vehicle payment service through the input device.

10. The in-vehicle payment service apparatus of claim 1, wherein the processor is configured to allow the display to display a selected menu and payment information for all vehicles in the group driving mode, and wherein the display includes an audio video navigation screen (AVNT).

11. An in-vehicle payment service method comprising:
receiving information through an input device in a vehicle from a user;
identifying the received information; and
controlling the received information to be displayed on a display in the vehicle, wherein controlling the received information includes:
managing a payment state for the received information;
transferring information for the payment state to a specific vehicle in a group driving mode; and
allowing the specific vehicle to perform a payment approval.

12. The in-vehicle payment service method of claim ii, wherein controlling the received information includes:
allowing at least two or more vehicles to be set as vehicles in the group driving mode by identifying information input through an input device in each vehicle; and
allowing a first vehicle in the group driving mode to be set as the specific vehicle.

13. The in-vehicle payment service method of claim 12, wherein controlling the received information includes allowing a first vehicle in the group driving mode to perform a menu selection for vehicles other than the first vehicle.

14. The in-vehicle payment service method of claim 13, wherein controlling the received information includes allowing the first vehicle in the group driving mode to perform a payment for a menu selected by the vehicles other than the first vehicle.

15. The in-vehicle payment service method of claim ii, wherein controlling the received information includes:
identifying whether a corresponding vehicle selects the group driving mode, whether the corresponding vehicle selects a same destination as the specific vehicle, whether the corresponding vehicle shares the same destination as the specific vehicle, or whether the corresponding vehicle sets a same point of interest (POI), based on information input through the input device in each vehicle; and
allowing the corresponding vehicle to be set as a group driving mode vehicle for the group driving mode.

16. The in-vehicle payment service method of claim ii, wherein controlling the received information includes:
identifying whether the specific vehicle in the group driving mode selects a group payment mode;
selecting a vehicle for a group payment based on the group payment mode; and
controlling the selected vehicle to perform the payment.

17. The in-vehicle payment service method of claim ii, wherein controlling the received information includes:
identifying whether a payment request occurs from remaining vehicles in the group driving mode to the specific vehicle; and
allowing the remaining vehicles to select a license plate number or a vehicle information list for the specific vehicle for the payment request.

18. The in-vehicle payment service method of claim ii, wherein controlling the received information includes:
identifying whether each vehicle in the group driving mode is subscribed to an in-vehicle payment service; and
allowing the display in the vehicle to display a guide pop-up screen, a login screen, or a card registration screen for performing the in-vehicle payment service.

19. The in-vehicle payment service method of claim 18, wherein controlling the received information includes:
allowing each vehicle in the group driving mode to identify the guide pop-up screen, the login screen, or the card registration screen, which is displayed through a display in each vehicle; and
allowing each vehicle in the group driving mode to register the in-vehicle payment service through the input device in each vehicle.

20. The in-vehicle payment service method of claim ii, wherein controlling the received information includes allowing the display to display a selected menu and payment information for all vehicles in the group driving mode, wherein the display includes an audio video navigation screen (AVNT).
